(19) United States
(12) Patent Application Publication
(10) Pub. No.: US 2019/0064899 A1
(43) Pub. Date: Feb. 28, 2019

(54) ELECTRONIC APPARATUS AND CABLE

(71) Applicant: KABUSHIKI KAISHA TOSHIBA, Tokyo (JP)

(72) Inventors: Takashi Doi, Fuchu Tokyo (JP); Ichiro Tomoda, Hamura Tokyo (JP); Nobuaki Suzuki, Tokyo (JP)

(21) Appl. No.: 15/884,826

(22) Filed: Jan. 31, 2018

(30) Foreign Application Priority Data
Aug. 31, 2017 (JP) 2017-167359

(51) Int. Cl. G06F 1/26; G06F 9/4401; G06F 13/38; G06F 13/42

(52) U.S. Cl. CPC G06F 1/266; G06F 9/4411; G06F 2213/0016; G06F 13/4282; G06F 2213/0042; G06F 13/385

(57) ABSTRACT

According to one embodiment, an electronic apparatus is connectable with an external apparatus via a cable, the cable conforming to a first standard. The electronic apparatus includes a connector and control circuitry. The control circuitry is configured to supply power to a memory via a power supply line and read cable information, if the electronic apparatus is connected with an external apparatus via the cable. The control circuitry is configured to inactivate a signal of a HPD, if the cable information does not indicate that the cable supports a mode to transmit a signal of a second standard different from the first standard. The control circuitry is configured to activate the signal of the HPD if the cable information indicates the cable supports the mode.

### CROSS-REFERENCE TO RELATED APPLICATIONS

This application is based upon and claims the benefit of priority from Japanese Patent Application No. 2017-167359, filed Aug. 31, 2017, the entire contents of which are incorporated herein by reference.

### FIELD

Embodiments described herein relate generally to an electronic apparatus and a cable.

### BACKGROUND

Currently, a cable including transmission path formed of a metal wire is often used for signal transmission between electronic apparatuses. For example, High-Definition Multimedia Interface (HDMI; registered trademark) or the like is well known as an example of an interface which transmits digital video signals in a non-compression format.

In contrast, cables used for the signal transmission between electronic apparatuses have been variously developed, and exactly determining whether the cable conforms to the standard desired by the user or not is often difficult.

This situation damages convenience for users and is required to be improved.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of an overall system according to the embodiments.

FIG. 2 is a table showing an example of a data structure of EMCA-compatible/incompatible information according to the embodiments.

FIG. 3 is a block diagram showing a structural example of a cable according to the embodiments.

FIG. 4 is a sequence chart showing an example of an operation in a case of transmitting an HDMI standard signal with the cable according to the embodiments.

FIG. 5 is a sequence chart showing an example of another operation in a case of transmitting the HDMI standard signal with the cable according to the embodiments.

FIG. 6 is a sequence chart showing an example of the other operation in a case of transmitting the HDMI standard signal with the cable according to the embodiments.

FIG. 7 is a sequence chart showing an example of the other operation in a case of transmitting the HDMI standard signal with the cable according to the embodiments.

FIG. 8 is a block diagram showing an example of an overall system according to a modified example of the embodiments.

### DETAILED DESCRIPTION

In general, according to one embodiment, an electronic apparatus is connectable with an external apparatus via a cable, the cable conforming to a first standard. The electronic apparatus includes a connector and control circuitry. The connector conforms to the first standard, connectable with the cable, the cable includes a memory that stores cable information, a power supply line that supplies power to the memory, and a signal line that transmits at least a signal of a hot plug detect. The control circuitry is configured to supply power to the memory via the power supply line and read the cable information, if the electronic apparatus is connected with the external apparatus via the cable. The control circuitry is configured to inactivate the signal of the hot plug detect, if the cable information does not indicate that the cable supports a mode to transmit a signal of a second standard different from the first standard. The control circuitry is configured to activate the signal of the hot plug detect if the cable information indicates the cable supports the mode.

Various embodiments will be described hereinafter with reference to the accompanying drawings. The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

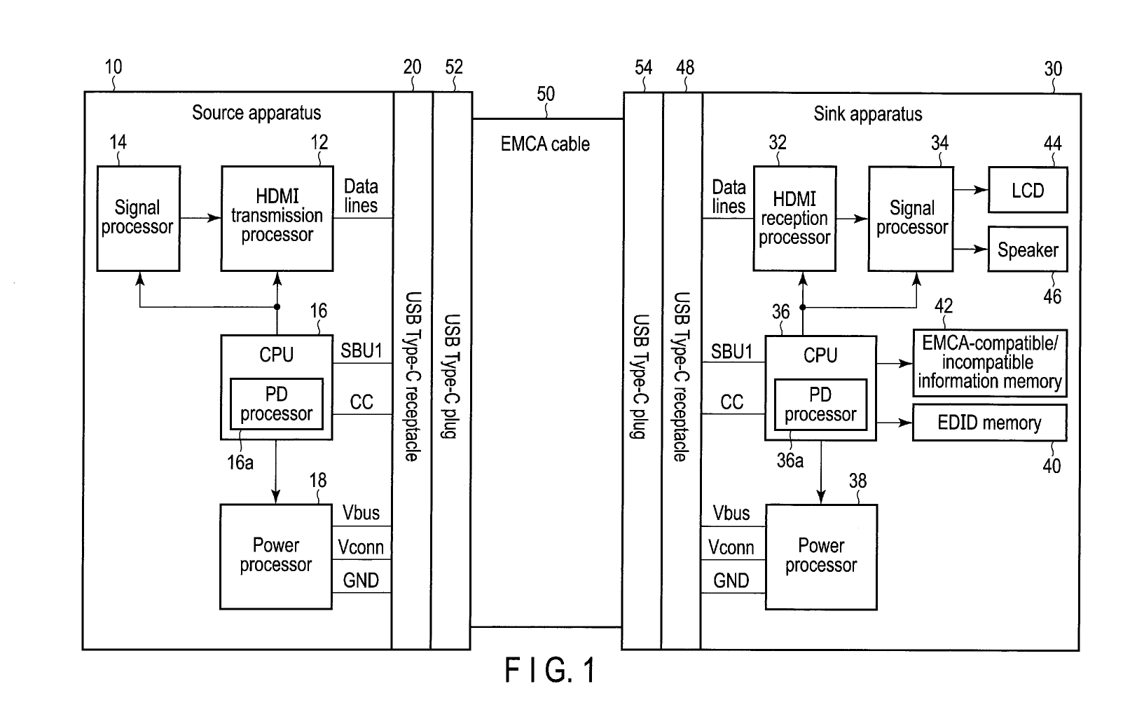

FIG. 1 shows an example of an overall system according to the embodiments. The system is composed of a transmitter 10 which transmits a video signal, a receiver 30 which receives the video signal, and a cable 50 for digital video signal transmission which is connected between the transmitter 10 and the receiver 30. Various interfaces to transmit digital video signals, for example, DisplayPort (registered trademark), HDMI, USB Type-C Alternate mode(registered trademark), Mobile High-Definition Link (MHL) (registered trademark), HD BaseT (registered trademark), VbyOne (registered trademark), Thunderbolt (registered trademark), and the like have been developed. USB Type-C Alternate mode is a mode to transmit signals of the other standards with a connector/cable of USB Type-C(registered trademark), and includes DisplayPort Alternate mode (registered trademark), MHL Alternate mode (registered trademark), HDMI Alternate mode (registered trademark), Thunderbolt Alternate mode (registered trademark), and the like in accordance with the other standards.

In the present embodiment, for example, transmission of an HDMI standard signal with a USB Type-C connector/cable will be explained. In addition, in the present embodiment, the USB Type-C cable is a cable of Electronically Marked Cable Assembly (EMCA). In HDMI, the transmitter is called a source apparatus while the receiver is called a sink apparatus.

The source apparatus 10 includes an optical disc player, a set-top box, a video camera, a personal computer, a smartphone, and the like. The sink apparatus 30 includes a television receiver, a monitor, a projector, a personal computer, a smartphone, and the like. Connectors (USB Type-C plugs) 52 and 54 are connected to both ends of the EMCA cable 50. The USB Type-C plugs 52 and 54 are detachably connected to connectors (USB Type-C receptacles) 20 and 48 on the apparatus side. The EMCA cable 50 is bidirectional and can be operated if both of the USB Type-C plugs is connected to the source apparatus 10 or the sink apparatus 30.

[Source Apparatus]

The source apparatus 10 includes an HDMI transmission processor 12, a signal processor 14, a CPU 16 (control circuitry), a power processor 18, and a USB Type-C receptacle 20. The CPU 16 further includes a power delivery (PD) processor 16a.

The signal processor 14 supplies a video signal, an audio signal and a control signal (including a status signal) to the HDMI transmission processor 12. The signal processor 14 converts a format of the video signal into a format corresponding to the resolution of the sink apparatus 30 and supplies the video signal to the HDMI transmission processor 12, under control of the CPU 16.

The HDMI transmission processor 12 transmits the video signal and the audio signal in Transition Minimized Differential Signaling (TMDS) system composed of four lanes, i.e., TMDS D0, TMDS D1, TMDS D2, and TMDS CLK, by using the data line. The CPU 16 controls operations of the HDMI transmission processor 12, the signal processor 14, and the power processor 18.

A PD processor 16a incorporated in the CPU 16 executes role swap with a apparatus connected via the EMCA cable 50, by using Configuration Channel (CC) line, to set a relationship between the sink and the source, a relationship between the USB host and the, apparatus, and the like. In addition, the PD processor 16a executes negotiation (power negotiation) concerning the power and the apparatus (sink apparatus 30) connected via the EMCA cable 50, by using the CC line to set a magnitude of the power which is to be supplied.

Furthermore, in HDMI Alternate mode, the PD processor 16a executes negotiation concerning the HDMI communication using the USB PD protocol with the sink apparatus 30 connected via the EMCA cable 50, by using the CC line, and then executes setting of pins used to transmit the video signal and the audio signal, 5V assertion (more specifically, output of a message corresponding to a +5V signal), reading EDID, and the like. Moreover, Hot Plug Detect (HPD) is supplied to the PD processor 16a through SBU1 line in the HDMI Alternate mode.

The power processor 18 supplies drive power to each of the units provided in the source apparatus 10. In addition, the power processor 18 supplies bus power by using Vbus line. More specifically, the power processor 18 supplies the power of a magnitude set by the power negotiation of the PD processor 16a to the sink apparatus 30 by using the Vbus line. Furthermore, the power processor 18 supplies the power to the EMCA cable 50 and a circuit exclusive for the EMCA cable, more specifically, a first E-marker 62, by using Vconn line, under instructions from the PD processor 16a. When the power is supplied from the Vconn to the first E-marker 62, the PD processor 16a reads cable information stored in the first E-marker 62.

[Sink Apparatus]

The sink apparatus 30 includes an HDMI reception processor 32, a signal processor 34, a CPU 36 (control circuitry), a power processor 38, an Extended Display Identification Data (EDID) memory 40, an EMCA-compatible/incompatible information memory 42, an LCD display 44, a speaker 46, and a USB Type-C receptacle 48. The CPU 36 further includes a PD processor 36a.

The LCD display 44 and the speaker 46 are used not only to output video and voice, but also to notify the user that the cable of the embodiment (EMCA cable 50) has been connected and that a cable different from the embodiment has been connected (warning information to be explained below). The notification includes text display, icon display, message voice synthesis, beep generation, and the like. If the source apparatus 10 includes notification means such as a display unit, a speaker, and the like, the source apparatus 10 may notify the user that the cable of the embodiments or a cable different from the embodiments has been connected.

The signal processor 34 is supplied with the video signal and the audio signal from the HDMI reception processor 32. The video signal output from the signal processor 34 is displayed on the LCD display 44 while the audio signal is output from the speaker 46. The CPU 36 controls operations of the HDMI reception processor 32, the signal processor 34, and the power processor 38.

A PD processor 36a incorporated in the CPU 36 executes role swap with a apparatus connected via the EMCA cable 50, by using CC line, to set a relationship between the sink and the source, a relationship between the USB host and the apparatus, and the like, similarly to the PD processor 16a incorporated in the source apparatus 10. In addition, the PD processor 36a executes power negotiation with the apparatus (source apparatus 10) connected via the EMCA cable 50, by using the CC line, to set a magnitude of the power which is to be received.

Furthermore, in HDMI Alternate mode, the PD processor 36a executes negotiation concerning the HDMI communication using the USB PD protocol with the source apparatus 10 connected via the EMCA cable 50, by using the CC line, and executes setting of pins used to receive the video signal and the audio signal, acquisition of version information indicating the version of the source apparatus 10, and the like. In addition, the PD processor 36a executes HPD assertion by using SBU1 line, in the HDMI Alternate mode. More specifically, the PD processor 36a supplies HPD to the source apparatus 10.

The EDID memory 40 stores EDID which is a data set to hold information on the function and the performance of the sink apparatus 30. EDID also indicates a power supplying ability of the sink apparatus 30. The EDID memory 40 is not limited to a RAM, but may be a ROM or a flash memory. In HDMI Alternate mode, the source apparatus 10 can access the EDID memory 40 by using the CC line (via the CPU 36) and learn the settings recommended by or corresponding to the sink apparatus 30 and the power supplying ability of the sink apparatus 30, based on EDID.

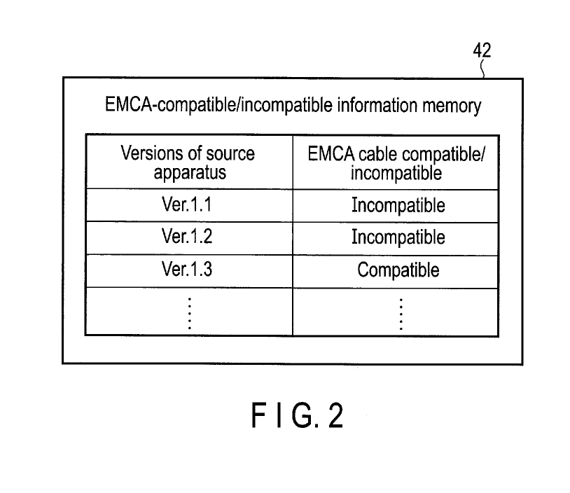

As shown in FIG. 2, the EMCA-compatible/incompatible information memory 42 stores EMCA-compatible/incompatible information in which the version of the source apparatus 10 is associated with information on whether the source apparatus 10 of this version is compatible with the EMCA cable 50 or not.

The power processor 38 supplies drive power to each of the units provided in the sink apparatus 30. In addition, the power processor 38 is supplied with bus power by using Vbus line. More specifically, the power processor 38 receives the power of a magnitude set by the power negotiation of the PD processor 36a, from the source apparatus 10, by using the Vbus line. Furthermore, the power processor 38 supplies the power to the EMCA cable 50 and a circuit exclusive for the EMCA cable, more specifically, a second E-marker 64, by using Vconn line, under instructions from the PD processor 36a. When the power is supplied from the Vconn to the second E-marker 64, the PD processor 36a reads cable information stored in the second E-marker 64.

Examples of pin mapping for transmission of the HDMI standard signal using the USB Type-C connector/cable are shown in Table 1 and Table 2.

TABLE 1

| | |
|---|---|
| USB Type-C | HDMI |

| Pin | Function | Function |
|---|---|---|
| A1 | GND | |
| A2 | TX1+ | TMDS D1+ |
| A3 | TX1− | TMDS D1− |
| A4 | Vbus | |
| A5 | CC1 | CEC/SCL/SDA |
| A6 | D+ | |
| A7 | D− | |
| A8 | SBU1 | HPD HEC/ARC− |
| A9 | Vbus | |
| A10 | RX2− | TMDS D0+ |
| A11 | RX2+ | TMDS D0− |
| A12 | GND | |

TABLE 2

| | |
|---|---|
| USB Type-C | HDMI |

| Pin | Function | Function |
|---|---|---|
| B1 | GND | |
| B2 | TX2+ | TMDS CLK− |
| B3 | TX2− | TMDS CLK+ |
| B4 | Vbus | |
| B5 | CC2 | +5 V POWER |
| B6 | | |
| B7 | | |
| B8 | SBU2 | UTILITY HEC/ARC+ |
| B9 | Vbus | |
| B10 | RX1− | TMDS D2− |
| B11 | RX1+ | TMDS D2+ |
| B12 | GND | |

As shown in Table 1, A2 and A3 pins of the USB Type-C connector/cable function as TX1+ and TX1− when transmitting the USB standard signal and function as TMDS D1+ and TMDS D1− when transmitting the HDMI standard signal. In addition, A5 pin functions as CC1 (CC) when transmitting the USB standard signal and functions as a Consumer Electronics Control (CEC)/SCL/SDA-multiplexed channel when transmitting the HDMI standard signal. Furthermore, A8 pin functions as SBU1 when transmitting the USB standard signal and functions as HPD HEC/ARC− when transmitting the HDMI standard signal. A10 and A11 pins function as RX2− and RX2+ when transmitting the USB standard signal and function as TMDS D0+ and TMDS D0− when transmitting the HDMI standard signal.

Similarly, as shown in Table 2, B2 and B3 pins of the USB Type-C connector/cable function as TX2+ and TX2−when transmitting the USB standard signal and function as TMDS CLK− and TMDS CLK+ when transmitting the HDMI standard signal. In addition, B5 pin functions as CC2 (Vconn) when transmitting the USB standard signal and functions as +5V POWER when transmitting the HDMI standard signal. Furthermore, B8 pin functions as SBU2 when transmitting the USB standard signal and functions as UTILITY HEC/ARC+ when transmitting the HDMI standard signal. B10 and B11 pins function as RX1− and RX1+ when transmitting the USB standard signal and function as TMDS D2− and TMDS D2+ when transmitting the HDMI standard signal.

[Cable]

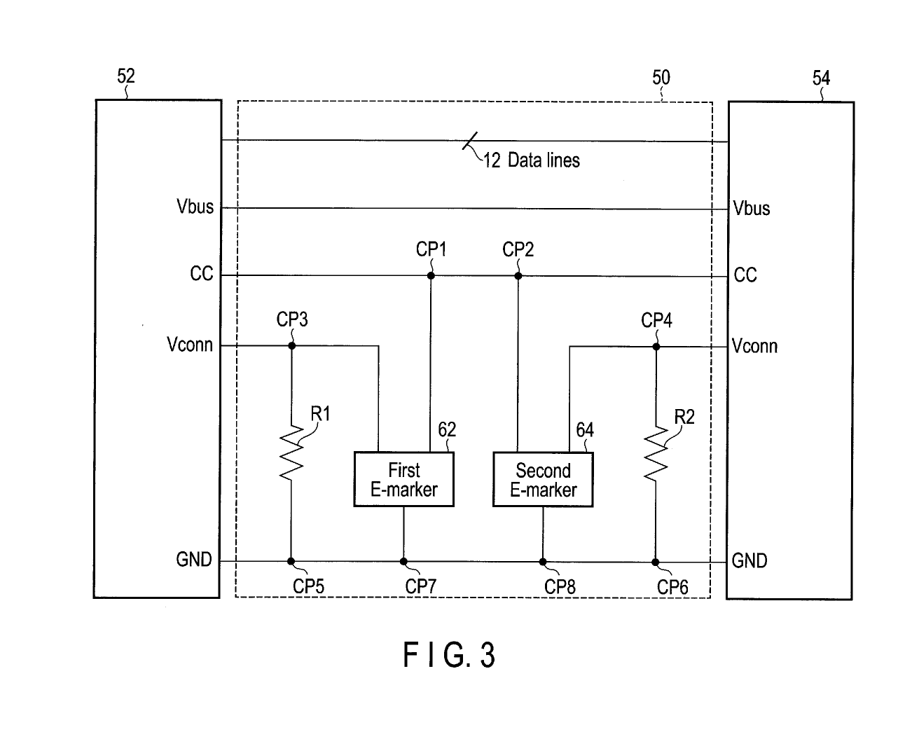

Next, the EMCA cable 50 will be explained with reference to FIG. 3.

As shown in FIG. 3, the first E-marker 62 and the second E-marker 64 are provided in the EMCA cable 50. Two E-markers 62 and 64 are provided in the cable 50, but are not limited to this example and only one E-marker may be provided in the cable. The first E-marker 62 and the second E-marker 64 are ROM, and the cable information is stored in the first E-marker 62 and the second E-marker 64.

The cable information is information which is read by the PD processor 16a shown in FIG. 1, representing, for example, at least one of information indicating that the cable is authorized by HDMI Founder (registered trademark), information indicating that the cable is authorized by HDMI Forum (registered trademark), information indicating an upper limit of a signal transmission speed, information indicating a cable length, information indicating a protocol supported by the cable, cable vender information, and the like.

As shown in FIG. 3, the Vbus line constituting the EMCA cable 50 extends to connect Vbus terminals in the plugs 52 and 54 on both ends. In addition, the CC line extends to connect CC terminals in the plugs 52 and 54 on both ends, and also extends to connect with the first E-marker 62 at first junction point CP1 and connect with the second E-marker 64 at second junction point CP2.

The Vconn line extending from Vconn terminal in the plug 52 extends to connect with the first E-marker 62 and also extends to connect with GND line via first resistance R1 at third junction point CP3. Similarly, the Vconn line extending from Vconn terminal in the plug 54 extends to connect with the second E-marker 64 and also extends to connect with the GND line via second resistance R2 at fourth junction point CP4. The GND line extends to connect GND terminals in the plugs 52 and 54 at both ends, extends to connect with one of the Vconn lines via the first resistance R1 at fifth junction point CP5, and extends to connect with the other Vconn line via second resistance R2 at sixth junction point CP6. In addition, the GND line extends to connect with the first E-marker 62 at first junction point CP7 and connect with the second E-marker 64 at eighth junction point CP8.

A plurality of data lines to transmit video signals extend between the plugs 52 and 54, though not illustrated in detail in FIG. 3.

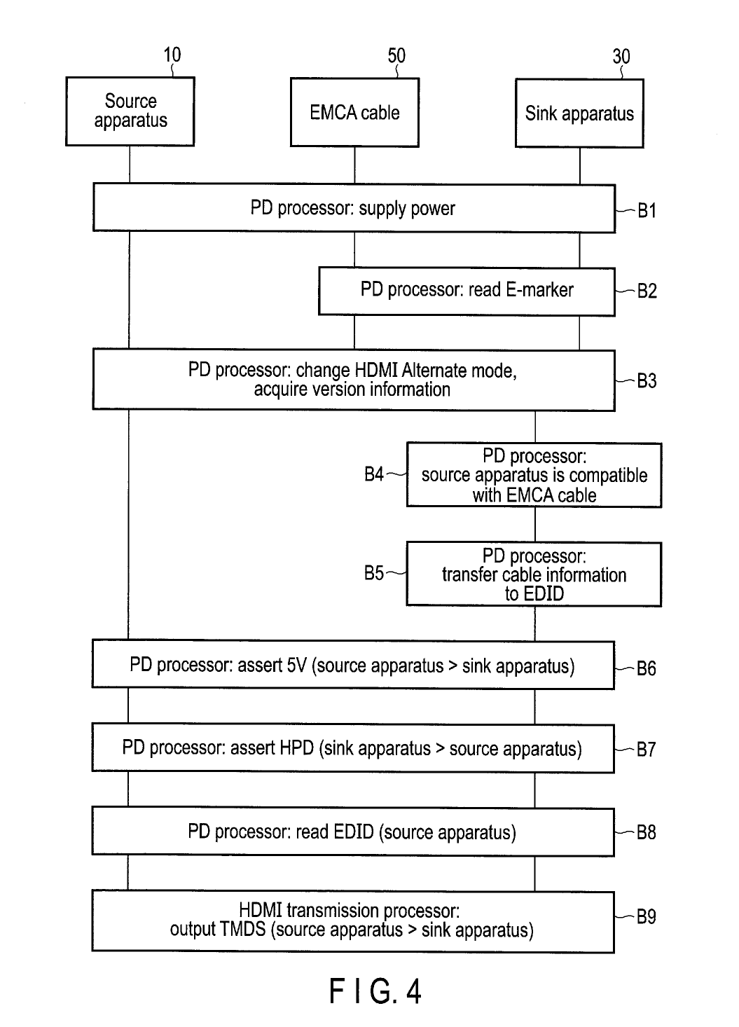

Operations of transmitting the HDMI standard signal with the cable 50 according to the embodiments will be explained with reference to a sequence chart of FIG. 4. FIG. 4 shows operations in a case where both of the source apparatus 10 and the sink apparatus 30 are compatible with the EMCA cable 50 and the EMCA cable 50 conforms to the HDMI standard.

First, if the EMCA cable 50 is connected to link two electronic apparatus, the PD processors 16a and 36a provided in the respective electronic apparatuses execute role swap with the CC lines to set one of the electronic apparatuses as the source apparatus 10 and the other as the sink apparatus 30 and to set one of the electronic apparatuses as the USB host and the other as the apparatus.

In addition, each of the PD processors 16a and 36a executes power negotiation with the CC line to set a magnitude of the power to be supplied and received between the electronic apparatuses. After that, power supply is executed. More specifically, the power processor 18 on the source apparatus 10 side supplies power of the set magnitude to the sink apparatus 30 by using the Vbus line under instructions from the PD processor 16a on the source apparatus 10 side. The power processor 38 on the sink apparatus 30 side receives the power supplied from the source apparatus 10 (block B1).

The PD processor 36a on the sink apparatus 30 side instructs the power processor 38 to supply the power to the second E-marker 64 provided in the EMCA cable 50. After that, the PD processor 36a reads the cable information from the second E-marker 64 driven with the 5V power supplied from the power processor 38 with the Vconn line (block B2).

The read cable information is assumed to include at least information indicating whether the EMCA cable 50 is an EMCA cable conforming to the HDMI standard or not. In the present operation example, the read cable information is assumed to include at least information indicating that the EMCA cable 50 is an EMCA cable conforming to the HDMI standard as mentioned above.

If the signal transmission mode is changed to the HDMI Alternate mode, the PD processor 36a on the sink apparatus 30 side executes negotiation with the PD processor 16a on the source apparatus 10 side with the CC line which functions as the CEC/SCL/SDA-multiplexed channel and acquires the version information indicating the version of the source apparatus 10 (block B3).

The PD processor 36a on the sink apparatus 30 side determines whether the version of the source apparatus 10 indicated by the acquired version information is compatible with the EMCA cable 50 or not, by referring to the EMCA-compatible/incompatible information memory 42. In the present operation example, as explained above, the PD processor 36a on the sink apparatus 30 side determines that the source apparatus 10 is compatible with the EMCA cable 50 since it is assumed that both of the source apparatus 10 and the sink apparatus 30 are compatible with the EMCA cable 50 (block B 4).

The PD processor 36a on the sink apparatus 30 side transfers the cable information read by the processing in block B2 to EDID stored in the EDID memory 40, based on the determination result in block B4 (block B5).

The PD processor 16a on the source apparatus 10 side executes 5V assertion. More specifically, if the signal transmission mode is changed to the HDMI Alternate mode, the PD processor 16a outputs a message corresponding to +5V signal to the sink apparatus 30 with the CC line which functions as the CEC/SCL/SDA-multiplexed channel (block B6).

If the PD processor 36a on the sink apparatus 30 side receives the input of the message from the source apparatus 10, the PD processor 36a recognizes (detects) connection of the source apparatus 10. After that, HPD assertion is executed. More specifically, the PD processor 36a supplies a signal (HPD) indicating that the EDID memory 40 can be read in HDMI, to the source apparatus 10, with the SBU1 line which functions as HPD HEC/ARC−. In other words, the PD processor 36a sets HPD to be active (High voltage level) (i.e., the PD processor 36a activates HPD) (block B7).

If HPD is set to be active, the PD processor 16a on the source apparatus 10 side reads EDID stored in the EDID memory 40 in the sink apparatus 30, with the CC line which functions as the CEC/SCL/SDA-multiplexed channel (block B8).

After that, the PD processor 16a on the source apparatus 10 side determines whether the EMCA cable 50 is a cable conforming to the HDMI standard or not, based on the cable information transferred to the read EDID. In the present operation example, as explained above, the PD processor 16a determines that the HDMI signal can be transmitted since it is assumed that the cable information indicates the EMCA cable conforming to the HDMI standard.

The signal processor 14 on the source apparatus 10 side converts the format of the video signal into a format corresponding to the resolution of the sink apparatus 30 indicated by the read EDID, under control of the CPU 16. The HDMI transmission processor 12 on the source apparatus 10 side outputs (transmits) to the sink apparatus 30 the format-converted video signal supplied from the signal processor 14 in TMDS using a plurality of data lines (block B9) and ends the operations.

According to the above-explained operations of FIG. 4, the transmission of the HDMI standard signal is implemented with the USB Type-C connector/cable, and the HDMI standard video signal can be displayed on the LCD display 44 on the sink apparatus 30 side. According to this, the user can recognize that the USB Type-C connector/cable connecting the source apparatus 10 with the sink apparatus 30 conforms to the HDMI standard.

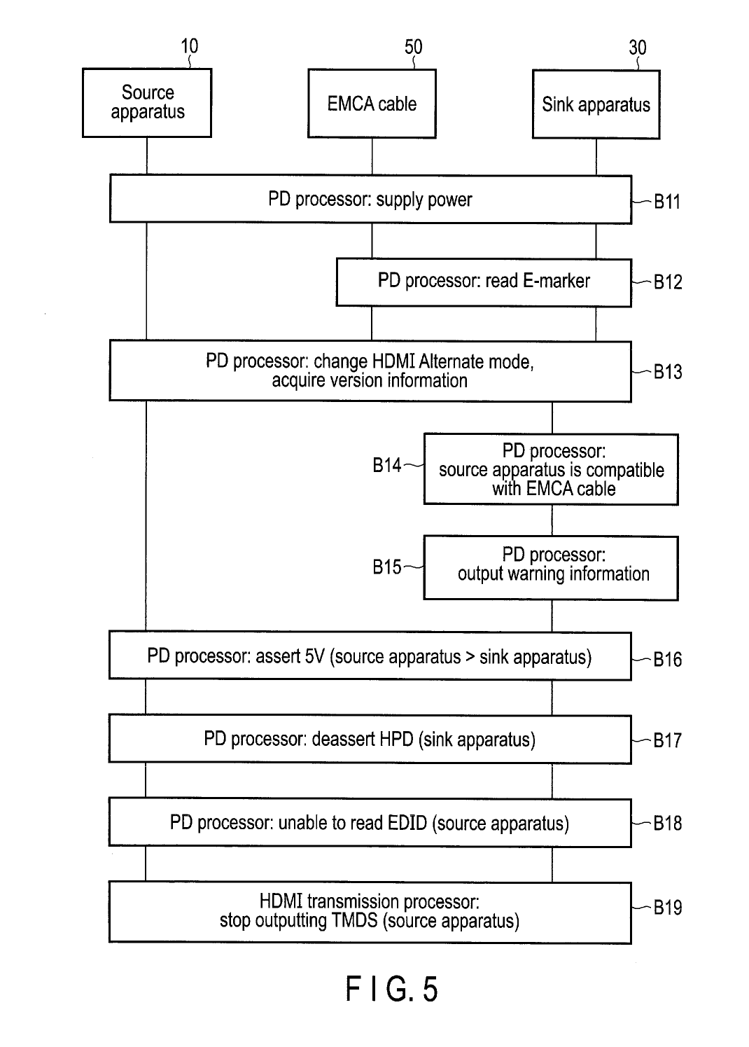

Next, other operations of transmitting the HDMI standard signal with the cable 50 according to the embodiments will be explained with reference to a sequence chart of FIG. 5. FIG. 5 shows operations in a case where, unlike the case shown in FIG. 4, the source apparatus 10 is incompatible with the EMCA cable 50, the sink apparatus 30 is compatible with the EMCA cable 50, and the EMCA cable 50 conforms to the HDMI standard. Detailed explanations of the same processing as that shown in FIG. 4 are omitted below.

First, the same processing as the processing in blocks B1 to B3 is executed (blocks B11 to B13).

After that, the PD processor 36a on the sink apparatus 30 side determines whether the version of the source apparatus 10 indicated by the acquired version information is compatible with the EMCA cable 50 or not, by referring to the EMCA-compatible/incompatible information memory 42. In the present operation example, as explained above, the PD processor 36a determines that the source apparatus 10 is not compatible with the EMCA cable 50 since it is assumed that the source apparatus 10 is incompatible with the EMCA cable 50 (block B14).

Based on the processing result in block B14, the signal processor 34 on the sink apparatus 30 side outputs warning information to at least one of the LCD display 44 and the speaker 46, under instructions from the PD processor 36a. According to this, the user can be notified that the source apparatus 10 is incompatible with the EMCA cable 50 (block B15).

Next, the PD processor 16a on the source apparatus 10 side executes 5V assertion, similarly to the processing in block B6 (block B16).

If the PD processor 36a on the sink apparatus 30 side receives the input of the message corresponding to the +5V signal based on the processing in block B16, the PD processor 36a recognizes connection of the source apparatus 10. Then, the PD processor 36a executes HPD deassertion by considering the determination that the source apparatus 10 is incompatible with the EMCA cable 50 in the processing in block B14. More specifically, the PD processor 36a does not supply HPD to the source apparatus 10 with the SBU1 line which functions as HPD HEC/ARC−. In other words, the PD processor 36a sets HPD to be inactive (Low voltage level) (i.e., the PD processor 36a inactivates HPD) (block B17).

Even if the source apparatus 10 incompatible with the EMCA cable 50, i.e., HPD assertion is executed, the processing in block B17 is the processing resulting from the fact that information on the EMCA cable 50 cannot be read from EDID.

Since the message corresponding to the +5V signal is output to the sink apparatus 30 in the processing in block B16 but HPD is not supplied from the sink apparatus 30 (i.e., HPD is inactive), the PD processor 16a on the source apparatus 10 side recognizes that reading the EDID memory 40 is not permitted (block B18).

After that, the PD processor 16a on the source apparatus 10 side determines that the transmission of the HDMI signal is disabled, based on the processing result in block B18. In accordance with this, the HDMI transmission processor 12 on the source apparatus 10 side stops outputting the signal to the sink apparatus 30 in TMDS (block B19) and ends the operations.

According to the above-explained operations shown in FIG. 5, the user can recognize that the source apparatus 10 is incompatible with the EMCA cable 50 by means of the LCD display 44 and the speaker 46. In other words, even the user having little knowledge in the present technical field can easily find a reason why the video signal or the audio signal is not output from the sink apparatus 30.

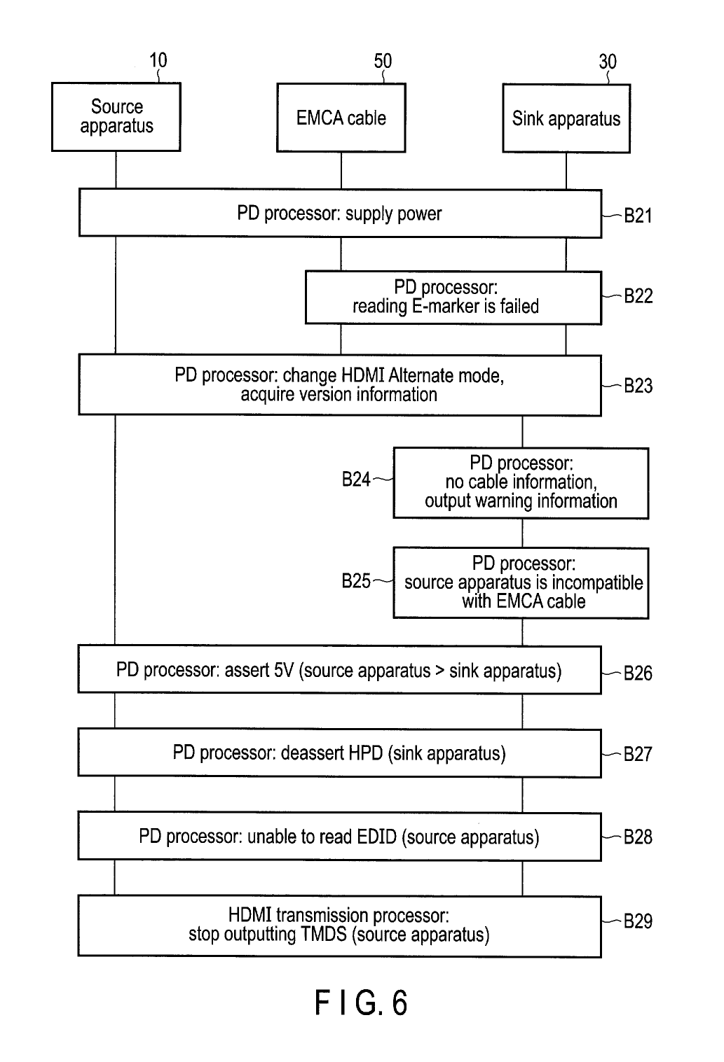

Next, other operations of transmitting the HDMI standard signal with the cable 50 according to the embodiments will be explained with reference to a sequence chart of FIG. 6. FIG. 6 shows operations in a case where, unlike FIG. 4 and FIG. 5, the source apparatus 10 is incompatible with the EMCA cable 50, the sink apparatus 30 is compatible with the EMCA cable 50, and the EMCA cable 50 does not conform to the HDMI standard.

First, if the EMCA cable 50 is connected to link two electronic apparatuses, the PD processors 16a and 36a provided in the respective electronic apparatuses execute role swap. In addition, each of the PD processors 16a and 36a executes power negotiation to set a magnitude of the power to be supplied and received between the electronic apparatuses. After that, power supply processing of supplying the power of the set magnitude from the power processor 18 on the source apparatus 10 side to the power processor 38 on the sink apparatus 30 side is executed (block B21).

Next, the PD processor 36a on the sink apparatus 30 side instructs the power processor 38 to supply the power to the second E-marker 64 provided in the EMCA cable 50. After that, the PD processor 36a reads the cable information from the second E-marker 64 driven with the 5V power supplied from the power processor 38 with the Vconn line. In the present operation example, reading the cable information by the PD processor 36a is assumed to be failed. The failure of reading the cable information is assumed to indicate a case where the PD processor 36a cannot obtain the cable information from the second E-marker 64 or a case where the PD processor 36a can obtain the cable information from the second E-marker 64 but the cable information indicates that the EMCA cable 50 is an EMCA cable which does not conform to the HDMI standard (block B22).

If the signal transmission mode is changed to the HDMI Alternate mode, the PD processor 36a on the sink apparatus 30 side executes negotiation with the PD processor 16a on the source apparatus 10 side and acquires the version information indicating the version of the source apparatus 10 (block B23).

Based on the failure of reading the cable information in the processing in block B22, the signal processor 34 on the sink apparatus 30 side outputs warning information to at least one of the LCD display 44 and the speaker 46, under instructions from the PD processor 36a. According to this, the user can be notified that the EMCA cable 50 does not conform to the HDMI standard (block B24).

The warning information is the message indicating that the EMCA cable 50 does not conform to the HDMI standard (not supporting the HDMI standard), more specifically, the message indicating that the cable cannot be used due to inapplicability to the HDMI standard, the message indicating that a video signal of the HDMI standard cannot be displayed with the cable, the message indicating exchange of cables, and the like.

The PD processor 36a on the sink apparatus 30 side determines whether the version of the source apparatus 10 indicated by the acquired version information is compatible with the EMCA cable 50 or not, by referring to the EMCA-compatible/incompatible information memory 42. In the present operation example, as mentioned above, the PD processor 36a determines that the source apparatus 10 is not compatible with the EMCA cable 50 since it is assumed that the sink apparatus 30 is compatible with the EMCA cable 50 but the source apparatus 10 is incompatible with the EMCA cable 50 (block B25).

The signal processor 34 may further output warning information indicating that the source apparatus 10 is incompatible with the EMCA cable 50, as well as the warning information in block B24, to at least one of the LCD display 44 and the speaker 46, under instructions from the PD processor 36a.

Next, the PD processor 16a on the source apparatus 10 side executes 5V assertion (block B26).

If the PD processor 36a on the sink apparatus 30 side receives the input of the message corresponding to the +5V signal based on the processing in block B26, the PD processor 36a recognizes that the source apparatus 10 has been connected. Then, the PD processor 36a does not execute supply of HPD to the source apparatus 10 by considering the determination that the source apparatus 10 is incompatible with the EMCA cable 50 in the processing in block B25. In other words, the PD processor 36a sets HPD to be inactive (i.e., the PD processor 36a inactivates HPD) (block B27).

Since HPD is not supplied from the sink apparatus 30 (i.e., HPD is inactive) although the message corresponding to the +5V signal is output to the sink apparatus 30 in the processing in block B26, the PD processor 16a on the source apparatus 10 side recognizes that reading the EDID memory 40 is not permitted (block B28).

After that, the PD processor 16a on the source apparatus 10 side determines that the transmission of the HDMI signal is disabled, based on the processing result in block B28. In accordance with this, the HDMI transmission processor 12 on the source apparatus 10 side stops outputting the signal to the sink apparatus 30 in TMDS (block B29) and ends the operations.

According to the above-explained operations shown in FIG. 6, the user can recognize that the EMCA cable 50 connecting the source apparatus 10 with the sink apparatus 30 does not conform to the HDMI standard, by means of the LCD display 44 and the speaker 46. In other words, even the user having little knowledge in the present technical field can easily find a reason why the video signal or the audio signal is not output from the sink apparatus 30.

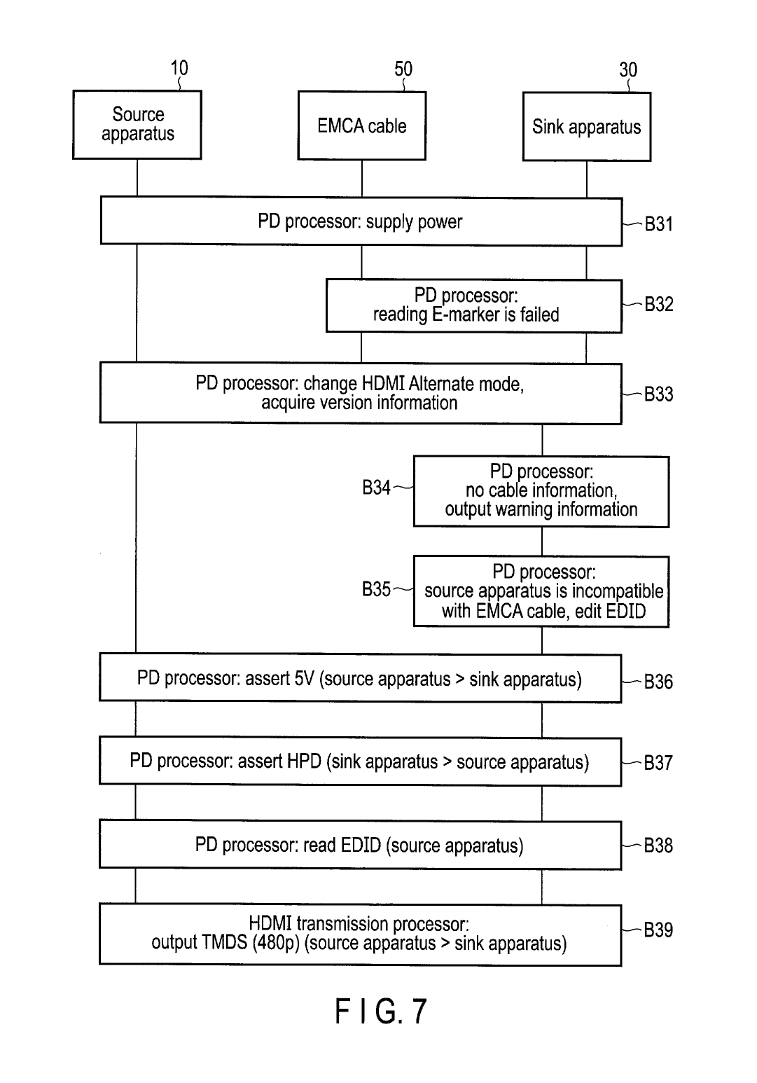

Next, other operations of transmitting the HDMI standard signal with the cable 50 according to the embodiments will be explained with reference to a sequence chart of FIG. 7. FIG. 7 shows operations in a case where, unlike the cases shown in FIG. 4 to FIG. 6, both of the source apparatus 10 and the sink apparatus 30 are compatible with the EMCA cable 50 but the EMCA cable 50 does not conform to the HDMI standard. Detailed explanations of the same processing as that shown in FIG. 6 are omitted below.

First, the same processing as the processing in blocks B21 to B24 is executed (blocks B31 to B34).

After that, the PD processor 36a on the sink apparatus 30 side determines whether the version of the source apparatus 10 indicated by the acquired version information is compatible with the EMCA cable 50 or not, by referring to the EMCA-compatible/incompatible information memory 42. In the present operation example, as mentioned above, the PD processor 36a determines that the source apparatus 10 is compatible with the EMCA cable 50 since it is assumed that both of the source apparatus 10 and the sink apparatus 30 are compatible with the EMCA cable 50.

Since the EMCA cable 50 does not conform to the HDMI standard but the source apparatus 10 is compatible with the EMCA cable 50, the PD processor 36a on the sink apparatus 30 side executes processing of rewriting (editing) the information on the video format of EDID stored in the EDID memory 40 to the essential format (480p) alone (block B35).

Next, the PD processor 16a on the source apparatus 10 side executes 5V assertion (block B36).

If the PD processor 36a on the sink apparatus 30 side receives the input of the message corresponding to the +5V signal based on the processing in block B36, the PD processor 36a recognizes that the source apparatus 10 has been connected. The PD processor 36a outputs HPD to the source apparatus 10 by considering that the source apparatus 10 is compatible with the EMCA cable 50. In other words, the PD processor 36a sets HPD to be active (i.e., the PD processor 36a activates HPD) (block B37).

If HPD is set to be active, the PD processor 16a on the source apparatus 10 side reads EDID stored in the EDID memory 40 in the sink apparatus 30 (block B38).

After that, the signal processor 14 on the source apparatus 10 side converts the format of the video signal into the essential format (480p) indicated by the read EDID, under control of the CPU 16. The HDMI transmission processor 12 on the source apparatus 10 side outputs (transmits) to the sink apparatus 30 the video signal of the essential format supplied from the signal processor 14 in TMDS using a plurality of data lines (block B39) and ends the operations.

According to the above-explained operations shown in FIG. 7, the user can recognize that the EMCA cable 50 currently connecting the source apparatus 10 with the sink apparatus 30 does not conform to the HDMI standard, by means of the LCD display 44 and the speaker 46. In addition, the user can also recognize that the EMCA cable 50 does not conform to the HDMI standard, from the situation that the video signal output to the LCD display 44 is rough.

The HDMI transmission processor 12 of the source apparatus 10 stops output of the signal to the sink apparatus 30 in FIG. 5 and FIG. 6, but the present embodiment example is not limited to this and the HDMI transmission processor 12 may output the video signal of the essential format (480p) to the sink apparatus 30, similarly to, for example, FIG. 7.

In contrast, the HDMI transmission processor 12 of the source apparatus 10 outputs the video signal of the essential format (480p) to the sink apparatus 30 in FIG. 7, but the present embodiment example is not limited to this and the HDMI transmission processor 12 may stop the output of the signal to the sink apparatus 30, similarly to, for example, FIG. 5 and FIG. 6.

In addition, the sink apparatus 30 reads the cable information from the second E-marker 64 in FIG. 4 to FIG. 7, but the present embodiment example is not limited to this and the source apparatus 10 may read the cable information from the first E-marker 62 and determine whether the EMCA cable 50 conforms to the HDMI standard or not. In this case, the information indicating the result of determination of the source apparatus 10 is output to the sink apparatus 30 together with the version information of the source apparatus 10 when the signal transmission mode is changed to the HDMI Alternate mode.

Alternately, the information indicating the result of determination of the source apparatus 10 may be reflected based on execution of 5V assertion, i.e., a request to set HPD to be active (i.e., a request to activate HPD).

The sink apparatus 30 estimates whether the source apparatus 10 is compatible with the EMCA cable 50 or not, based on the version of the source apparatus 10, in the present embodiment, but the present embodiment is not limited to this. It may be determined whether the source apparatus 10 is compatible with the EMCA cable 50 or not, by outputting the information indicating whether the source apparatus 10 is compatible with the EMCA cable 50 or not, instead of the version information, to the sink apparatus 30.

To respond to a case where the EMCA cable 50 conforms to the HDMI standard but a transmission band which can be supported by the EMCA cable 50 is lower than a transmission band which can be supported by the sink apparatus 30, the sink apparatus 30 may further include a function of partially invalidating the transmission band which can be supported by itself in accordance with the transmission band which can be supported by the EMCA cable 50.

In addition, the source apparatus 10 and the sink apparatus 30 may further include a function of invalidating their own HDMI Ethernet Channel (HEC) function in accordance with the EMCA cable 50 when recognizing that the EMCA cable 50 does not support HEC.

### Modified Example

The type of the plug of the EMCA cable 50 is USB Type-C in the present embodiment, but the present embodiment is not limited to this and the type of the plug of the EMCA cable 50 may be USB Type-C on the source apparatus 10 side and HDMI Type-A on the sink apparatus 30 side. In this case, too, the same operations as those shown in FIG. 4 to FIG. 7 can be implemented.

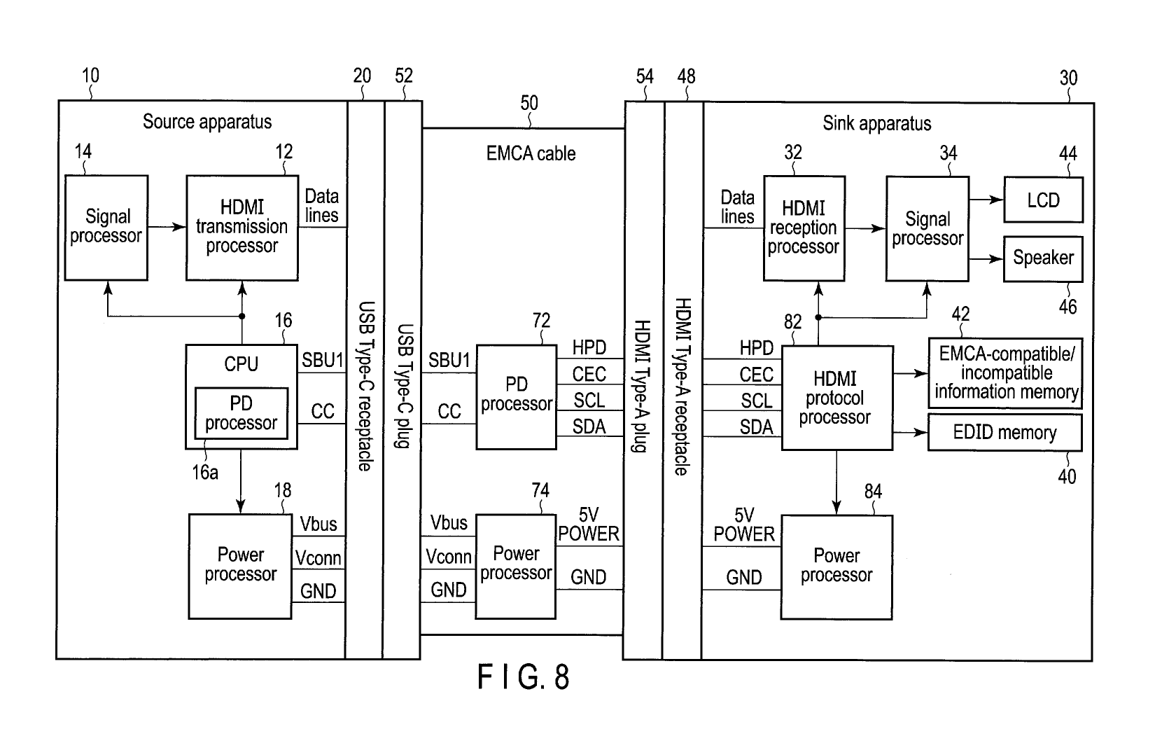

The system configuration in this case is shown in FIG. 8. In this case, as shown in FIG. 8, a PD processor 72 corresponding to the PD processor 36a shown in FIG. 1 and a power processor 74 corresponding to the power processor 38 are provided in the EMCA cable 50, and an HDMI protocol processor 82 connected to the PD processor 72 via signal lines (CEC line, SCL line and SDA line) defined under the HDMI standard and a power processor 84 connected to the power processor 74 via signal lines (5V POWER line and GND line) defined under the HDMI standard are provided in the sink apparatus 30.

The HDMI protocol processor 82 controls the PD processor 72 such that the PD processor 72 operates similarly to the PD processor 36a, and the power processor 84 controls the power processor 74 such that the power processor 74 operates similarly to the power processor 38. Thus, the same operations as those shown in FIG. 4 to FIG. 7 can be implemented and the same advantages can be obtained.

An example of pin arrangement of the plug on the sink apparatus 30 side (i.e., HDMI Type-A pin arrangement) is shown below.

TABLE 3

| Pin | Definition |
|---|---|
| 1 | TMDS Data2+ |
| 2 | TMDS Data2 Shield |
| 3 | TMDS Data2− |
| 4 | TMDS Data1+ |
| 5 | TMDS Data1 Shield |
| 6 | TMDS Data1− |
| 7 | TMDS Data0+ |
| 8 | TMDS Data0 Shield |
| 9 | TMDS Data0− |
| 10 | TMDS Clock+ |
| 11 | TMDS Clock Shield |
| 12 | TMDS Clock− |
| 13 | CEC |
| 14 | Reserved (N.C. on apparatus) |
| 15 | SCL |
| 16 | SDA |
| 17 | DDC/CEC Ground |
| 18 | +5 V POWER |
| 19 | Hot Plug Detect |

According to the above-explained embodiment, an electronic apparatus and a cable capable of improving the convenience for users in relation to the cable used for signal transmission between electronic apparatuses can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus connectable with an external apparatus via a cable, the cable conforming to a first standard, the electronic apparatus comprising:
a connector, conforming to the first standard, connectable with the cable, the cable comprising a memory that stores cable information, a power supply line that supplies power to the memory, and a signal line that transmits at least a signal of a hot plug detect,
control circuitry configured to:
supply power to the memory via the power supply line and read the cable information, if the electronic apparatus is connected with the external apparatus via the cable;
inactivate the signal of the hot plug detect, if the cable information does not indicate that the cable supports a mode to transmit a signal of a second standard different from the first standard; and
activate the signal of the hot plug detect if the cable information indicates the cable supports the mode.

2. The electronic apparatus of claim 1, wherein the control circuitry is further configured to inactivate the signal of the hot plug detect, if the control circuitry fail to read the cable information.

3. The electronic apparatus of claim 1, wherein the control circuitry is further configured to transmit the cable information to the external apparatus after reading the cable information.

4. The electronic apparatus of claim 1, further comprising:
a screen configured to display a video signal from the external apparatus,
wherein the control circuitry is further configured to display on the screen a message related with that the cable does not support the mode.

5. The electronic apparatus of claim 1, wherein
the cable is an electronically marked cable assembly (EMCA) cable, and
the control circuitry is further configured to inactivate the signal of the hot plug detect, if the external apparatus is incompatible with the EMCA cable.

6. The electronic apparatus of claim 1, wherein the control circuitry is further configured to change a compatible video signal format from a first format to an essential format, if the cable information indicates the cable does not support the mode.

7. The electronic apparatus of claim 1, wherein the control circuitry is further configured to invalidate a part of a transmission band of the electronic apparatus in accordance with a transmission band of the cable, if the cable information indicates the cable support the mode and the transmission band of the cable is lower than the transmission band of the electronic apparatus.

8. The electronic apparatus of claim 1, wherein the control circuitry is further configured to invalidate a mode to transmit a signal of a third standard capable of being supported by the electronic apparatus and the external apparatus, if the cable information does not indicate that the cable supports the mode.

9. A cable, conforming to a first standard, configured to connect a first electronic apparatus with a second electronic apparatus, the cable comprising:
a first connector connectable with the first electronic apparatus;
a second connector connectable with the second electronic apparatus;
a memory configured to store cable information of the cable;
a power supply line configured to supply power from at least one of the first electronic apparatus or the second electronic apparatus to the memory; and
a signal line configured to transmit at least a signal of a hot plug detect between the first electronic apparatus and the second electronic apparatus,
wherein
when the first electronic apparatus is connected with the first connector and the second electronic apparatus is connected with the second apparatus, the power supply line configured to supply the power from at least one of the first electronic apparatus and the second electronic apparatus to the memory and the cable information is read by at least one of the first electronic apparatus and the second electronic apparatus,
when the cable information does not indicate that the cable support a mode to transmit a signal of a second standard different from the first standard, the signal of the hot plug detect is inactived by at least one of the first electronic apparatus and the second electronic apparatus, and
when the cable information indicates that the cable supports the mode, the signal of the hot plug detect is activated by at least one of the first electronic apparatus and the second electronic apparatus.

10. The cable of claim 9, wherein
the first connector is a connector of a first type conforming to the first standard, and
the second connector is a connector of a second type conforming to the second standard.

11. The cable of claim 9, wherein
the first connector is a connector of a USB type, and
the second connector is a connector of an HDMI type.

12. The cable of claim 9, wherein
the first standard is USB Type-C,
the second standard is HDMI,
the mode is HDMI Alternate mode, and
the cable information is indicated by E-marker.

13. An electronic apparatus connectable with an external apparatus via a cable, the cable conforming to a first standard, the electronic apparatus comprising:
a connector, conforming to the first standard, connectable with the cable, the cable comprising a memory that stores cable information, a power supply line that supplies power to the memory, and a signal line that transmits at least a signal of a hot plug detect,
a control circuitry configured to:
supply power to the memory via the power supply line and read the cable information, if the electronic apparatus is connected with the external apparatus via the cable;
output a request to inactivate the signal of the hot plug detect to the external apparatus, if the cable information does not indicate that the cable supports a mode to transmit a signal of a second standard different from the first standard; and
output the request to activate the hot plug detect to the external apparatus, if the cable information indicates the cable supports the mode.
